(19) United States
(12) Patent Application Publication
(10) Pub. No.: US 2006/0187287 A1
(43) Pub. Date: Aug. 24, 2006

(54) Method of printing with overlapping paper feed

(75) Inventors: Mark J. Edwards, Lexington, KY (US); Tommy O. Lowe, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/062,059

(22) Filed: Feb. 18, 2005

(51) Int. Cl. B41J 2/01

(52) U.S. Cl. 347/104

(57) ABSTRACT

A method of printing on print media includes the steps of: transporting a first print medium from a first paper bin through a nip; determining an imaging area in which printing occurs on the first print medium and/or a second print medium; transporting the second print medium from a second paper bin to the nip; and overlapping the first print medium and the second print medium in the nip an amount which is dependent upon the determined imaging area.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND OF THE INVENTION

1. Field of the Invention

The present invention relates to a method of printing using an imaging device such as a printer, and, more particularly, to a method of printing to increase the throughput rate through such an imaging device.

2. Description of the Related Art

An ink jet printer receives print image data and places ink dots at selected pixel locations within an imaging area overlying the print medium. The ink jet printer typically includes an ink jet cartridge which is carried by a carriage assembly. The ink jet cartridge includes a printhead having a plurality of nozzles, from which ink is jetted onto the print medium at the selected pixel locations within the image area. The carriage assembly moves the printhead across the print medium in a scan direction while the ink drops are jetted onto selected pixel locations within a given raster line. Between passes of the printhead, the print medium is advanced a predetermined distance and the printhead is again scanned across the print medium. This process of advancing and printing while scanning continues down the entire printable area of the print medium.

Movement of the print medium into the print zone is typically controlled by feed rollers which are positioned prior to the printhead. While the print medium is under these feed rollers, the print medium advance is accurately controlled. Printing may occur using a single pass technique or a multiple pass technique. Regardless, competitive pressure is great to provide solutions for faster direct throughput on consumer ink jet printers. The faster ink jet printers, which are currently available, feed print media which are staged very close together (i.e., very little gap between successive sheets).

What is needed in the art is a method of printing which provides an increased throughput rate while concurrently maintaining high print quality.

### SUMMARY OF THE INVENTION

The present invention provides a method of printing with a plurality of print media which are overlapped a varying amount dependent upon the imaging areas and/or leading and trailing edges of the media.

The invention comprises, in one form thereof, a method of printing on print media, including the steps of: transporting a first print medium from a first paper bin through a nip; determining an imaging area in which printing occurs on the first print medium and/or a second print medium; transporting the second print medium from a second paper bin to the nip; and overlapping the first print medium and the second print medium in the nip an amount which is dependent upon the determined imaging area.

The invention comprises, in another form thereof, a method of printing on print media, including the steps of: transporting a first print medium through a nip; determining an imaging area in which printing occurs on the first print medium and/or a second print medium; sensing an edge of the first print medium and/or second print medium; and overlapping the second print medium and the first print medium in the nip such that the determined imaging area is aligned with the sensed edge.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic, side sectional view of an embodiment of an imaging device with an L path paper transport configuration which may be used to carry out the method of the present invention;

FIG. 2 is a schematic, front view of the imaging device shown in FIG. 1;

FIG. 3 is a graphical illustration of an embodiment of an overlapping print media arrangement of the present invention which may be achieved using the imaging device shown in FIGS. 1 and 2;

FIG. 4 is a schematic, side sectional view of another embodiment of an imaging device with a C path paper transport configuration which may be used to carry out the method of the present invention; and

FIG. 5 is a schematic, front view of the imaging device shown in FIG. 4.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

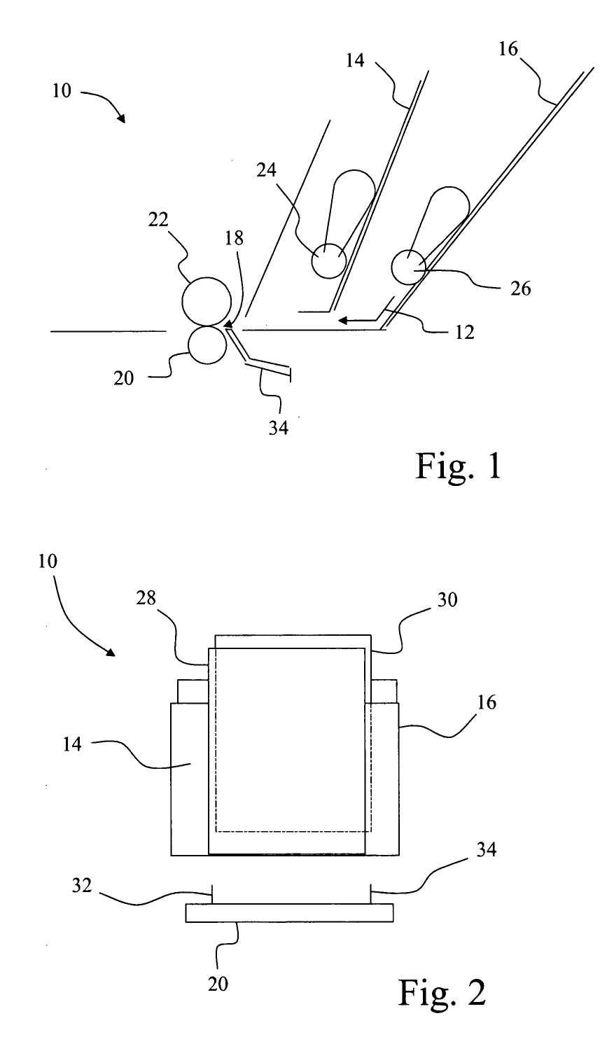

Referring now to the drawings, and more particularly to FIGS. 1 and 2, there is shown an embodiment of an imaging device 10 of the present invention which is used for carrying out a printing method of the present invention. In the embodiment shown, imaging device 10 is in the form of an ink jet printer, but may be differently configured depending upon the particular application. For example, imaging device 10 may be in the form of a photocopier, multi-function machine (MFM, also known as an AIO), etc.

In the embodiment shown, ink jet printer 10 has a paper transport path generally defining an L path configuration, as indicated by direction arrow 12. Printer 10 includes a first paper bin 14 and a second paper bin 16 from which a plurality of print media are selectively transported to a nip 18 between a feed roller 20 and backup roller 22. Of course, it will also be appreciated that roller 22 may be a feed roller and roller 20 may be a backup roller.

First paper bin 14 is physically closest to nip 18 and is termed a front feeder. Similarly, second paper bin 16 is farthest from nip 18 and is termed a rear feeder. First paper bin 14 includes a pick roller 24 associated therewith; and second paper bin 16 includes a pick roller 26 associated therewith. Each pick roller 24 and 26 is electrically coupled with and selectively controlled by a controller (not shown). The controller and pick roller 24 define a front feed autocompensator, and the controller and pick roller 26 define a rear feed autocompensator, taking into consideration factors such as media stack height, pick roll diameter and material type, media buckle, etc.

Referring now to FIG. 2, it may be observed that print media stack 28 within first paper bin 14 is offset in a lateral direction relative to print media stack 30 in second paper bin 16. An end of form (EOF) sensor 32 is positioned along an edge of print media stack 28 to detect a leading edge and/or trailing edge of a print medium from print media stack 28, while at the same time not detecting a leading edge and/or trailing edge of a print medium from print media stack 30. Similarly, an EOF sensor 34 is positioned to detect a leading edge and/or trailing edge of a print medium transported from print media stack 30, while at the same time being positioned so as not to detect the leading edge and/or trailing edge of a print medium from print media stack 28. Each EOF sensor 32 and 34 is coupled with a controller within printer 10. EOF sensors 32 and 34 are configured as optical sensors in the embodiment shown, but may be differently configured depending upon the application.

During use, print media are transported from each of first paper bin 14 and second paper bin 16 in an overlapped manner through nip 18 to increase the throughput rate, particularly when printer 10 is set in a draft quality print mode. The extent to which the print media are overlapped is dynamically varied from one print medium to another as the print media are transported through nip 18 in succession. Two primary parameters are used to determine the extent to which the print media are dynamically overlapped during use. One parameter is the sensed leading edge and/or trailing edge of a particular print medium. The other parameter is the lengthwise imaging area established by the print image data in which printing actually occurs on the given print medium. For example, print data for one print medium may use the entire available print medium (less margins), while print data for another print medium may only use the top half of the same size print medium (such as may occur on the last page of a letter). For a given print medium, the imaging area is defined by a start print position closest to the leading edge of the print medium and an end print position closest to the trailing edge of the print medium. Depending upon how the paper is overlapped, the leading edge and/or trailing edge of one print medium is overlapped to lie closely adjacent the start print position or end print position of an adjacent print medium.

A method of printing using the printer 10 shown in FIGS. 1 and 2 will now be described in further detail. For purposes of illustration, a three page print job will be described; however, it will be understood that any print job having a plurality of pages can be employed.

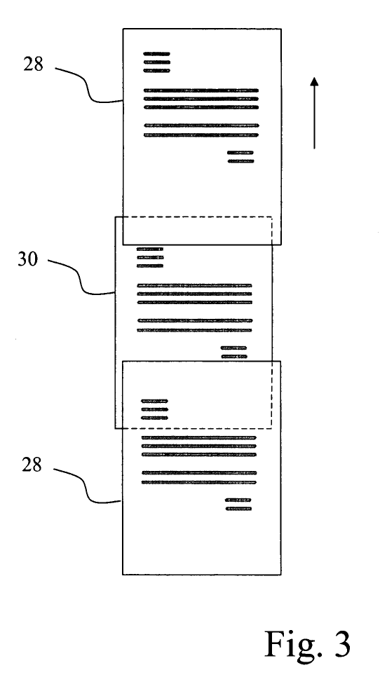

A print medium 28 is transported from first paper bin 14 to nip 18 using pick roller 24. A leading edge of the first print medium 28 (the top print medium 28 in FIG. 3) is sensed using EOF sensor 32, and print image data is printed on print medium 28 in the usual draft mode fashion. The arrow in FIG. 3 indicates the direction that the print medium is moving through printer 10. The imaging area including the start print position on the second print medium 30 is determined by or known by the controller within printer 10. The rear feeder autocompensator actuates pick roller 26 to advance second print medium 30 from second paper bin 16 to nip 18 such that second print medium 30 enters nip 18 under first print medium 28. The amount of overlap between first print medium 28 and second print medium 30 is determined so that the trailing edge of first print medium 28 lies closely adjacent to the start print position of the imaging area on second print medium 30. To this end, EOF sensor 34 detects the leading edge of second print medium 30 to accurately position the overlap between first print medium 28 and second print medium 30.

Because first print media stack 28 is offset in a lateral or transverse direction relative to print media stack 30 in second paper bin 16, it is likewise necessary to shift the print image data which is printed on second print medium 30 in the imaging area. The extent to which the print image data is shifted corresponds to the lateral offset between print media stack 28 and print media stack 30. The laterally offset print image data is then printed on second print medium 30 in standard draft mode fashion.

Third print medium 28 (the bottom print medium shown in FIG. 3) is then fed from first paper bin 14 to nip 18 using pick roller 24. As indicated above, the imaging area of second print medium 30 is known or determined by the controller within printer 10. Third print medium 28 is transported to nip 18 such that the leading edge thereof lies closely adjacent to the end print position of the imaging area upon second print medium 30 (see FIG. 3). To this end, the leading edge of third print medium 28 is sensed by EOF sensor 32 to accurately place the leading edge adjacent the end print position of second print medium 30 shown in FIG. 3. Third print medium 28 is printed in a normal draft mode fashion without an offset, since it was fed from first paper bin 14. The printing method as described above provides a printer with a throughput rate which is significantly increased without adversely affecting print quality.

In the embodiment shown above, first paper bin 14 is laterally offset relative to second paper bin 16 so that EOF sensors 32 and 34 can more easily sense the leading edge and/or trailing edge of a particular print medium. However, it may be possible to use sensors not requiring such a lateral offset.

Further, in the embodiment shown, print media from first paper bin 14 and second paper bin 16 are interleaved in an overlapping manner such that media adjacent the leading and trailing edge of a given print medium lie on the same side of the print medium. However, it may also be possible to overlap a print medium such that it lies “over” one adjacent print medium and “under” another adjacent print medium.

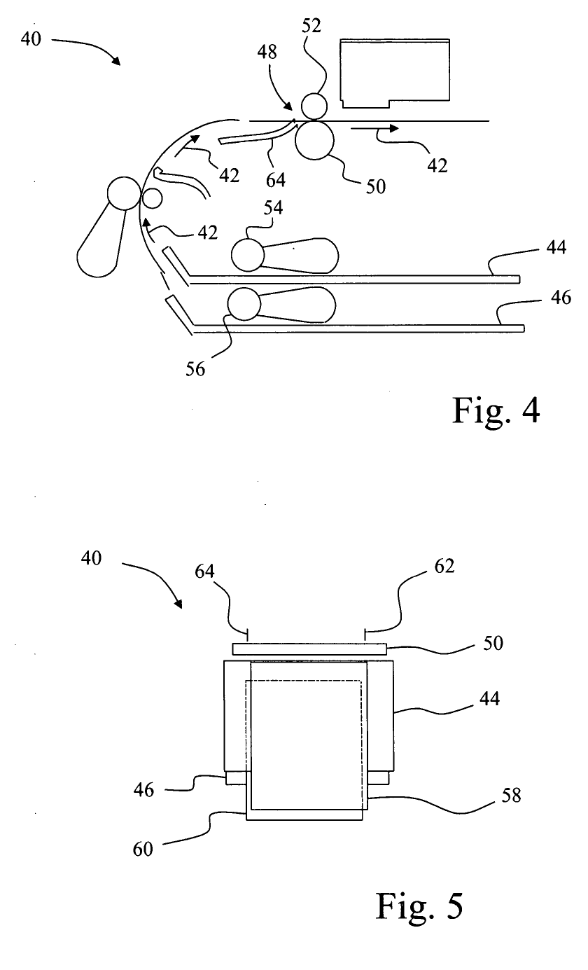

Referring now to FIGS. 4 and 5 there is shown another embodiment of an imaging device 40 in the form of an ink jet printer which may be used for carrying out the method of printing of the present invention. Print media are generally transported in a C path configuration through printer 40, as indicated by directional arrows 42. Similar to printer 10 shown in FIGS. 1 and 2, printer 40 likewise includes a first paper bin 44, second paper bin 46, nip 48 defined by feed roller 50 and backup roller 52, and pick roller 54 and pick roller 56 in first paper bin 44 and second paper bin 46, respectively. First paper bin 44 carries a print media stack 58 which is laterally offset in a transverse direction relative to a print media stack 60 carried by second paper bin 46, similar to the lateral offset between first paper bin 14 and second paper bin 16 shown in FIG. 2 and described above. The leading and/or trailing edge of print media within print media stack 58 is sensed using an EOF sensor 62 and the leading and/or trailing edge of print media from print media stack 60 is sensed using an EOF sensor 64.

The method of printing using a C path printer as shown in FIGS. 4 and 5 is similar to the method of printing described above with reference to FIGS. 1-3. In either case, the primary parameters affecting the extent of dynamic overlapping between adjacent print media are the leading and/or trailing edges of a print medium and the imaging area of the print medium.

While this invention has been described as set forth herein, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of printing on print media, comprising the steps of:
transporting a first print medium from a first paper bin through a nip;
determining an imaging area in which printing occurs on at least one of said first print medium and a second print medium;
transporting said second print medium from a second paper bin to said nip; and
overlapping said first print medium and said second print medium in said nip an amount which is dependent upon said determined imaging area.

2. The method of printing of claim 1, wherein said step of transporting said second print medium to said nip includes positioning said second print medium on a side of said first print medium opposite from which printing occurs in said imaging area.

3. The method of printing of claim 2, wherein said imaging area includes a start print position on said second print medium, and said overlapping step comprises positioning said start print position of said second print medium adjacent a trailing edge of said first print medium.

4. The method of printing of claim 2, wherein said overlapping occurs by transporting said second print medium to said nip while said first print medium is in said nip.

5. The method of printing of claim 1, including the steps of:
determining an imaging area in which printing occurs on at least one of said second print medium and a third print medium;
transporting said third print medium from said first paper bin to said nip; and
overlapping said second print medium and said third print medium in said nip an amount which is dependent upon said determined imaging area on at least one of said second print medium and said third print medium.

6. The method of printing of claim 5, wherein said step of transporting said third print medium to said nip includes positioning said third print medium on a side of said second print medium upon which printing occurs in said imaging area.

7. The method of printing of claim 6, wherein said imaging area includes an end print position on said second print medium, and said overlapping step comprises positioning a leading edge of said third print medium adjacent said end print position of said second print medium.

8. The method of printing of claim 7, wherein said overlapping occurs by transporting said third print medium to said nip while said second print medium is in said nip.

9. The method of printing of claim 1, wherein said first print medium and said second print medium are moved in an advance direction through said nip, and said second print medium is offset from said first print medium in a direction transverse to said advance direction.

10. The method of printing of claim 9, including the step of sensing at least one of a trailing edge of said first print medium at said offset, and a leading edge of said second print medium at said offset.

11. The method of printing of claim 9, including the step of shifting an imaging area of said second print medium an amount corresponding to said offset in said transverse direction.

12. The method of printing of claim 1, wherein said imaging area includes a start print position and an end print position.

13. The method of printing of claim 1, wherein said first print medium and said second print medium are transported through one of an L path configuration and a C path configuration in a printer.

14. The method of printing of claim 1, wherein said method of printing is carried out in an ink jet printer.

15. A method of printing on print media, comprising the steps of:
transporting a first print medium through a nip;
determining an imaging area in which printing occurs on at least one of said first print medium and a second print medium;
sensing an edge of at least one of said first print medium and said second print medium;
overlapping said second print medium and said first print medium in said nip such that said determined imaging area is aligned with said sensed edge.

16. The method of printing of claim 15, wherein said first print medium and said second print medium are moved in an advance direction through said nip, and said second print medium is offset from said first print medium in a direction transverse to said advance direction.

17. The method of printing of claim 16, wherein said sensing step is carried out at said offset.

18. The method of printing of claim 17, including the step of shifting an imaging area of said second print medium an amount corresponding to said offset in said transverse direction.

19. A method of printing on print media, comprising the steps of:
transporting a plurality of print media to a paper transport assembly;
determining imaging areas in which printing occurs on a plurality of said print media; and
overlapping said plurality of print media in said paper transport assembly an amount which is dependent upon said determined imaging areas.

20. The method of printing of claim 19, wherein said transporting step comprises transporting said plurality of print media in alternating fashion from one of a first paper bin and a second paper bin to said paper transport assembly.
